(19) United States
(12) Patent Application Publication
(10) Pub. No.: US 2026/0109028 A1
(43) Pub. Date: Apr. 23, 2026

(54) ROBOT APPARATUS AND CONTROL METHOD THEREOF

(71) Applicant: SAMSUNG ELECTRONICS CO., LTD., Suwon-si (KR)

(72) Inventors: Taehan KIM, Suwon-si (KR); Jaehyeon PARK, Suwon-si (KR); Jaemin YOON, Suwon-si (KR); Rakjoon CHUNG, Suwon-si (KR); Changsu HA, Suwon-si (KR); Heungwoo HAN, Suwon-si (KR)

(73) Assignee: SAMSUNG ELECTRONICS CO., LTD., Suwon-si (KR)

(21) Appl. No.: 19/357,719

(22) Filed: Oct. 14, 2025

Related U.S. Application Data
(63) Continuation of application No. PCT/KR2025/011352, filed on Jul. 30, 2025.

(30) Foreign Application Priority Data
Oct. 23, 2024 (KR) 10-2024-0146160
Dec. 10, 2024 (KR) 10-2024-0183081

(51) Int. Cl. B25J 9/16; B25J 13/08; B25J 15/02; B25J 15/04

(52) U.S. Cl. CPC B25J 9/1612; B25J 9/161; B25J 9/1653; B25J 13/088; B25J 15/0253; B25J 15/04

(57) ABSTRACT

Provided is a robot apparatus including: a main body; a robot arm connected to the main body and configured to selectively use a plurality of gripper tips; at least one sensor; memory storing at least one instruction; and at least one processor configured to execute the at least one instruction, wherein the at least one instruction, when executed by the at least one processor individually or collectively, causes the robot apparatus to: identify a characteristic of a target based on a sensing value of the at least one sensor; and control the robot arm to grip the target by using a gripper tip corresponding to the identified characteristic among the plurality of gripper tips.

### CROSS-REFERENCE TO RELATED APPLICATIONS

This application is a by-pass continuation of International Application No. PCT/KR2025/011352, filed on Jul. 30, 2025, which is based on and claims priority to Korean Patent Application No. 10-2024-0146160, filed in the Korean Intellectual Property Office on Oct. 23, 2024, and Korean Patent Application No. 10-2024-0183081, filed in the Korean Intellectual Property Office on Dec. 10, 2024, the disclosures of which are incorporated by reference herein in their entireties.

### 1. Field

This disclosure relates to a robot apparatus and a control method thereof, and particularly, to a robot apparatus including gripper tips and a control method thereof.

### 2. Description of Related Art

With the advancement of technology, robots are used in various fields while replacing human labor. In particular, robot apparatuses that can be used in fields such as manufacturing, construction, medicine, and aerospace, all of which involve delicate and elaborate tasks.

### SUMMARY

Related art robot apparatuses may use a single-shaped irreplaceable gripper tip, making it difficult to grip an object of a specific shape or material. Additionally, such robot apparatuses may have difficulty in gripping an object depending on the posture or position of an object even in the case of an identical object.

Provided is a robot apparatus including a plurality of robot arms and a control method thereof.

According to an aspect of the disclosure, a robot apparatus includes: a main body; a robot arm connected to the main body and configured to selectively use a plurality of gripper tips; at least one sensor; memory storing at least one instruction; and at least one processor configured to execute the at least one instruction, wherein the at least one instruction, when executed by the at least one processor individually or collectively, causes the robot apparatus to: identify a characteristic of a target based on a sensing value of the at least one sensor; and control the robot arm to grip the target by using a gripper tip corresponding to the identified characteristic among the plurality of gripper tips.

The robot arm may include: a rotator on which each of the plurality of gripper tips are mounted. Each of the plurality of gripper tips may be mounted in a different direction, and the at least one instruction, when executed by the at least one processor individually or collectively, may further cause the robot apparatus to: rotate the rotator such that the gripper tip corresponding to the identified characteristic faces the target.

The robot arm may include: a coupler detachably connected to the plurality of gripper tips. The at least one instruction, when executed by the at least one processor individually or collectively, may further cause the robot apparatus to: control the robot arm to detach the plurality of gripper tips from the coupler such that the gripper tip corresponding to the identified characteristic faces the target.

The plurality of gripper tips may include a first gripper tip and a second gripper tip. A contact surface of the second gripper tip may be larger than a contact surface of the first gripper tip, and the at least one instruction, when executed by the at least one processor individually or collectively, may further cause the robot apparatus to: based on a size of the target being less than a pre-set size range, control the robot arm to grip the target by using the first gripper tip; and based on the size of the target being greater than or equal to the pre-set size range, control the robot arm to grip the target by using the second gripper tip.

The plurality of gripper tips may include a first gripper tip and a second gripper tip. A contact surface of the second gripper tip may be larger than a contact surface of the first gripper tip, and the at least one instruction, when executed by the at least one processor individually or collectively, may further cause the robot apparatus to: based on identifying at least one object in a vicinity of the target, identify a spatial characteristic of a space where the target is located based on the sensing value of the at least one sensor; and select the gripper tip from among the plurality of gripper tips based on the spatial characteristic and the characteristic of the target.

The spatial characteristic may include information on at least one of a position of the target in the space, a distance between the target and the at least one object, and a contact relationship between the target and the at least one object, and the at least one instruction, when executed by the at least one processor individually or collectively, may further cause the robot apparatus to: based on the target being located at an edge portion of the space, control the robot arm to grip the target using the second gripper tip; based on the distance being less than a first pre-set distance, control the robot arm to grip the target using the first gripper tip; based on the distance being greater than or equal to the first pre-set distance, control the robot arm to grip the target using the second gripper tip; and based on the target and at least one of the at least one object being in contact with one another, control the robot arm to grip the target using the first gripper tip.

The at least one instruction, when executed by the at least one processor individually or collectively, may further cause the robot apparatus to select the gripper tip from among the plurality of gripper tips based on an operation to be performed after the target is gripped.

The plurality of gripper tips may include a first gripper tip and a second gripper tip. A contact surface of the second gripper tip may be larger than a contact surface of the first gripper tip, and the at least one instruction, when executed by the at least one processor individually or collectively, may further cause the robot apparatus to: based on an operation to be performed after the target is gripped being a lifting operation, control the robot arm to grip the target using the second gripper tip; based on the operation comprising changing a direction where the target is placed, control the robot arm to grip the target using the first gripper tip; and based on the operation comprising performing a task while moving the target within a pre-set range, control the robot arm to grip the target using the first gripper tip.

The memory may store a database of a plurality of types of gripper tips. Each of the plurality of types of gripper tips may correspond to one or more characteristics of the target, and the at least one instruction, when executed by the at least one processor individually or collectively, may further cause the robot apparatus to select, based on the database, the gripper tip corresponding to the characteristic of the target from among the plurality of gripper tips.

The memory may store an artificial intelligence model trained to select the gripper tip corresponding to the identified characteristic of the target from among the plurality of gripper tips, and the at least one instruction, when executed by the at least one processor individually or collectively, may further cause the robot apparatus to: input information on the characteristic of the target to the artificial intelligence model; and select the gripper tip based on an output value of the artificial intelligence model from among the plurality of gripper tips.

According to an aspect of the disclosure, a method of controlling a robot apparatus including at least one sensor and a robot arm capable of selectively using a plurality of gripper tips includes: identifying a characteristic of a target based on a sensing value of the at least one sensor; and controlling the robot arm to grip the target using a gripper tip corresponding to the identified characteristic among the plurality of gripper tips.

The robot arm may further include a rotator on which each of the plurality of gripper tips is mounted in a different direction, and the controlling the robot arm may further include rotating the rotator such that the gripper tip corresponding to the identified characteristic faces the target.

The plurality of gripper tips may include a first gripper tip and a second gripper tip, a contact surface of the second gripper tip may be larger than a contact surface of the first gripper tip, and the controlling the robot arm may further include, based on a size of the target being less than a pre-set size range, gripping the target using the first gripper tip, and based on a size of the target being greater than or equal to the pre-set size range, gripping the target using the second gripper tip.

The method may further include: identifying a spatial characteristic of a space where the target is located based on the sensing value of the at least one sensor, wherein the controlling the robot arm further comprises selecting a gripper tip of the robot arm, from among the plurality of gripper tips, based on the characteristic of the target.

The identifying the spatial characteristic of the space where the target is located based on the sensing value of the at least one sensor may include: identifying a characteristic of a grip point of the target based on the sensing value of the at least one sensor, and the selecting the gripper tip of the robot arm based on the characteristic of the target may include selecting the gripper tip of the robot arm based on the characteristic of the grip point, the spatial characteristic, and the characteristic of the target.

According to an aspect of the disclosure, a non-transitory computer readable medium has instructions stored therein, which when executed by at least one processor cause the at least one processor to execute a method of controlling a robot apparatus, the method including: identifying a characteristic of a target based on a sensing value of at least one sensor of the robot apparatus; and controlling a robot arm of the robot apparatus to grip the target using a gripper tip corresponding to the identified characteristic from among a plurality of gripper tips of the robot arm.

With regard to the method executed by the at least one processor based on the instructions stored in the non-transitory computer readable medium, the robot arm may further include a rotator on which each of the plurality of gripper tips is mounted in a different direction, and the controlling the robot arm may further include rotating the rotator such that the gripper tip corresponding to the identified characteristic faces the target.

With regard to the method executed by the at least one processor based on the instructions stored in the non-transitory computer readable medium, the plurality of gripper tips may include a first gripper tip and a second gripper tip, a contact surface of the second gripper tip may be larger than a contact surface of the first gripper tip, and the controlling the robot arm may further include, based on a size of the target being less than a pre-set size range, gripping the target using the first gripper tip, and based on a size of the target being greater than or equal to the pre-set size range, gripping the target using the second gripper tip.

With regard to the method executed by the at least one processor based on the instructions stored in the non-transitory computer readable medium, the method may further include: identifying a spatial characteristic of a space where the target is located based on the sensing value of the at least one sensor, and the controlling the robot arm may further include selecting the gripper tip, from among the plurality of gripper tips, based on the characteristic of the target.

With regard to the method executed by the at least one processor based on the instructions stored in the non-transitory computer readable medium, the identifying the spatial characteristic of the space where the target is located based on the sensing value of the at least one sensor may include: identifying a characteristic of a grip point of the target based on the sensing value of the at least one sensor, and the selecting the gripper tip of the robot arm based on the characteristic of the target may include selecting the gripper tip of the robot arm based on the characteristic of the grip point, the spatial characteristic, and the characteristic of the target.

One or more embodiments are described in the detailed description provided hereafter, and some of the embodiments are clearly understood from the detailed description, and other embodiments are suggested based on training from suggested embodiments.

### BRIEF DESCRIPTION OF THE DRAWINGS

The above-described, and other aspects and features of certain embodiments of the present disclosure may be understood more clearly from following description provided with reference to the accompanying drawings, in which:

FIG. 1 is a view of a robot apparatus according to one or more embodiments;

FIG. 2 is a view of a gripper according to one or more embodiments;

FIG. 3 is a view of a gripper tip according to one or more embodiments;

FIG. 4 is a block diagram of a robot apparatus according to one or more embodiments;

FIG. 5A and FIG. 5B are views provided to explain a method of selecting a gripper tip based on a characteristic of a target according to one or more embodiments;

FIGS. 6A, 6B, and 6C are views provided to explain a method of selecting a gripper tip based on a characteristic of a target according to one or more embodiments; and

FIGS. 7-10 are views of a flow of a method of operating a robot apparatus according to one or more embodiments.

### DETAILED DESCRIPTION

Hereafter, embodiments are specifically described with reference to the accompanying drawings. The embodiments set forth herein may be modified in various different forms. According to the present disclosure, specific embodiments may be illustrated in the drawings and described in the detailed description. However, the embodiments illustrated in the drawings are intended for a better understanding of embodiments of the disclosure. Accordingly, the embodiments set forth herein and the terms used herein are not intended to limit technical features of the subject matter of the disclosure to those of the specific embodiments, and are to be understood as including various modifications, equivalents or alternatives thereof.

Unless explicitly indicated otherwise, a singular form corresponding to an item may include a singular form or a plural form thereof.

In the disclosure, each of the phrases such as “A or B,” “at least one of A and B,” “at least one of A or B,” “A, B or C,” “at least one of A, B and C,” and “at least one of A, B or C” may include any one of the items listed together in a corresponding phrase or all possible combinations thereof.

The term “and/or” denotes including a combination or any of a plurality of relevant elements described.

In the disclosure, a term such as “1st,” “2nd,” or “first,” or “second” may be used merely to differentiate one element from another but not to limit the elements in another aspect (e.g., importance or order).

Based on one element (e.g., a first element) referred to as being “coupled with/to or connected with/to” another element (e.g., a second element) with or without the term “functionally” or “communicatively”, it is to be understood that one element may be connected to another element directly (e.g., in a wired manner), in a wireless manner, or through yet another element (e.g., a third element).

In the disclosure, terms such as “include,” or “have” and the like are used to indicate the presence of stated features, numbers, steps, operations, elements, components or a combination thereof, and do not imply exclusion of the presence or addition of one or more different features, numbers, steps, operations, elements, components or a combination thereof.

Based on one element referred to as being “connected with/to,” “coupled with/to,” “supporting,” or “contacting” another element, it is to be understood that one element is connected with/to another element, is coupled with/to another element, supports another element, or contacts another element directly or indirectly through yet another element (e.g., a third element).

In the disclosure, the expression “identical” may denote including a difference to the degree that a machining error range is considered as well as denoting complete identicalness.

Based on one element referred to as being placed “on” another element, it is to be understood that one element contacts another element and that yet another element is present between the two elements.

In the embodiments, the term “module” or “unit” may be integrated into at least one module and be implemented as at least one processor except for a “module” or a “unit” that needs to be implemented by specific hardware.

Operations performed by a module, a program, or another element, according to embodiments, may be executed sequentially, in parallel, repetitively, or heuristically, or at least part of the operations may be executed in a different order, may be omitted, or may add a different operation.

Various elements and regions in the drawings are schematically illustrated. Accordingly, the technical spirit of the disclosure is not limited by relative sizes or distances illustrated in the accompanying drawings.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Hereafter, a robot apparatus 1 according to one or more embodiments is described specifically with reference to the drawings.

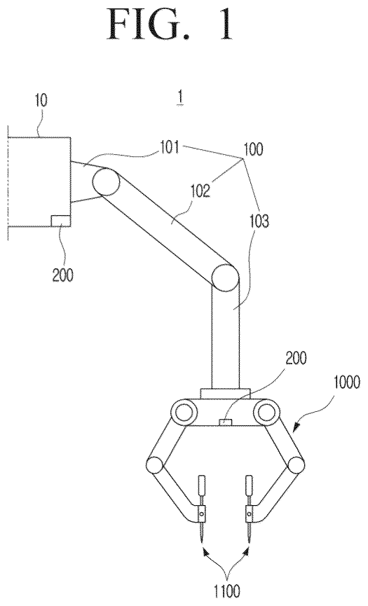

FIG. 1 is a view of a robot apparatus 1 according to at least one embodiment.

The robot apparatus 1 may include a main body 10, a robot arm 100, and at least one sensor 200.

The main body 10 is an element including devices for managing entire operations of the robot apparatus 1. The main body 10 is an element constituting the exterior of the robot apparatus 1. In FIG. 1, the main body 10 is simply shaped into a rectangle, but not necessarily limited thereto, and the main body 10 may be shaped into various types such as a body in the case of a humanoid robot, a core module in the case of a three-axis core module, a central module in the case of a quadruped robot, and the like. Additionally, the main body 10 may be shaped in a manner corresponding to the way that the main body is integrated with the robot arm and the gripper, or may be shaped in a manner corresponding to the way that the main body, the robot arm and the gripper are separated from one another and then assembled. The main body 10 may also be referred to as various terms such as a housing, a cabinet, a core module, a body and the like.

The robot arm 100 may be connected to or otherwise arranged on one side of the main body 10. The robot arm 100 is an element for moving the gripper 1000 to a specific position by moving each of a plurality of joints 101, 102, 103. The robot arm 100 may be formed in a manner corresponding to the way that the robot arm is integrated with the main body 10 or in a manner corresponding to the way that the robot arm exists as an independent module and is assembled (e.g., connected) to the main body 10.

The robot arm 100 may include a plurality of joints 101, 102, 103. The plurality of joints 101, 102, 103 may move in various ways around each axis. The plurality of joints 101, 102, 103 are all illustrated as an I-type module in FIG. 1, but not necessarily limited thereto, and the plurality of joints 101, 102, 103 may be shaped into various types of modules such as an L-type module and the like.

The robot arm 100 may include a gripper 1000 and a plurality of gripper tips 1100. The gripper 1000 may be shaped in a manner that corresponds to the way that the gripper is attached to ends of the plurality of joints 101, 102, 103. In a case where the plurality of joints 101, 102, 103 move the gripper 1000 to a specific position to perform a task, the gripper 1000 may perform the task at the specific position. For example, the gripper 1000 may be moved to a specific position after gripping a target. Additionally, the gripper 1000 may perform various tasks such as cleaning, tightening a screw and welding and the like after gripping a target.

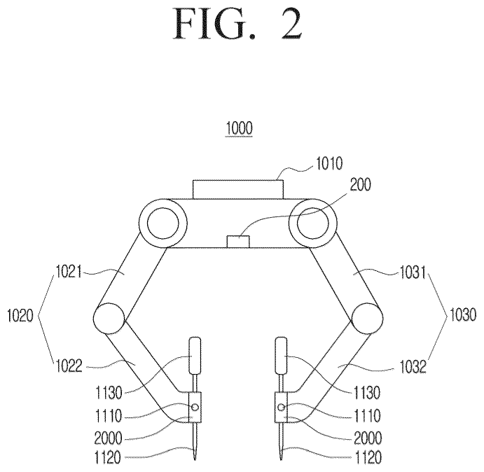

The robot arm 100 may include a plurality of gripper tips 1100. The plurality of gripper tips 1100 may be formed into different shapes. The gripper 1000 may be configured to grip a target by using a gripper tip having a shape of a sort corresponding to a characteristic of the target. Detailed description in relation to this is provided hereafter from FIG. 2.

The at least one sensor 200 may be disposed at the main body 10, on the robot arm 100, separate from the robot apparatus 1 (e.g., located at a position selected to provide a third-person perspective), and the like. The robot apparatus 1 may obtain information on a target or a surrounding shape based on a sensing value of the at least one sensor 200. The robot apparatus 1 may identify a characteristic of a target based on a sensing value of the at least one sensor 200. The robot apparatus 1 may identify a spatial characteristic of a space in which a target is placed base on a sensing value of the at least one sensor 200. Herein, the spatial characteristic denotes information on at least one of a position of a target in a space, a distance between a target and at least one object placed around (e.g., in the vicinity of) the target, and a contact relationship between a target and an object. Additionally, the robot apparatus 1 may identify a characteristic of a grip point of the robot arm 100 based on a sensing value of the at least one sensor 200. Herein, the characteristic of the grip point may vary depending on an operation of the robot apparatus 1. For example, in a case where the robot apparatus 1 lifts a target, the characteristic of the grip point may be a point at which torque of the target is minimized or may be a point near center of gravity of the target. In a case where the robot apparatus 1 rotates a target, the characteristic of the grip point may be a point that is farthest from a rotation center of the target. However, the characteristic of the grip point is not necessarily limited thereto, and the grip point for a given target may vary depending on an operation of the user. The robot apparatus 1 may identify various types of information based on a sensing value of the at least one sensor 200. The at least one sensor 200 may include a vision sensor, an infrared sensor, an ultrasonic sensor and the like. However, the at least one sensor 200 may not be necessarily limited thereto and may include various types of sensors capable of sensing a sensing value of a characteristic of a target, spatial information of a target, surrounding shape information, grip point information of a target and the like.

FIG. 2 is a view of a gripper 1000 according to one or more embodiments.

In FIG. 2, the gripper 1000 may include a first coupler 1010, a plurality of fingers 1020, 1030, a second connector 1110, a first gripper tip 1120, a second gripper tip 1130, and a rotator 2000.

The first coupler 1010 is an element for coupling with one side of the robot arm 100. The gripper 1000 may be coupled to the plurality of joints 101, 102, 103 of the robot arm 100 through the first coupler 1010. The first coupler 1010 may be coupled to the plurality of joints 101, 102, 103 based on various joint couplings such as a revolute joint coupling, a spherical joint coupling, a screw joint coupling and the like.

The plurality of fingers 1020, 1030 may be disposed to face each other with respect to a center of the gripper 1000. A first finger 1020 may include a plurality of first finger joints 1021, 1022. The second finger 1030 may include a plurality of second finger joints 1031, 1032.

The plurality of fingers 1020, 1030 may grip a target by using the plurality of finger joints respectively. The plurality of fingers 1020, 1030 may perform a task by using the plurality of finger joints respectively

The plurality of gripper tips 1100 may be coupled to the plurality of fingers 1020, 1030 through the second connector 1110. A first gripper tip 1120 and a second gripper tip 1130 may be disposed to face each other with respect to the second connector 1110. However, the plurality of gripper tips 1100 may not be necessarily limited thereto, and may be disposed at various positions, around the second connector 1110.

The first gripper tip 1120 is a gripper tip used to grip a target having a small contact surface. For example, the first gripper tip 1120 may be selected in a case where a target such as a thread, a string and an earbud and the like is gripped.

The second gripper tip 1130 is a gripper tip used to grip a target having a contact surface greater than that of a target gripped by the first gripper tip. For example, the second gripper tip 1130 may be selected in a case where a target such as shoes, an apple, a vacuum flask and the like is gripped.

However, the plurality of gripper tips 1100 may not be necessarily limited to the first gripper tip 1120 and the second gripper tip 1130, and may include a gripper tip of various shapes, forms and materials and the like depending on a characteristic of a target, a characteristic of a grip point, user settings, user tastes and the like.

The robot arm 100 may include a rotator 2000. The rotator 2000 may be formed in the way that the plurality of gripper tips 1100 is mounted in different directions through the second connector 1110. The rotator 2000 may be formed in a manner corresponding to the way that the rotator is integrated with the plurality of gripper tips 1100, or may be formed as an independent element. The robot arm 100 may rotate the rotator 2000 such that a gripper tip of a sort corresponding to a characteristic of a target, which is identified based on a sensing value of the at least one sensor 200, among the plurality of gripper tips 1100 may face the target. However, the robot arm 100 may not be necessarily limited thereto, and in a case where the rotator 2000 includes a motor, the rotator 2000 may rotate the second connector 1110 through the motor such that one of the plurality of gripper tips may face a target. While the embodiment shown in FIG. 2 shows two gripper tips 1120 and 1130 attached to each connector 1110, the disclosure is not limited thereto, and additional gripper tips may be attached at different points around the circumference of the connectors 1110.

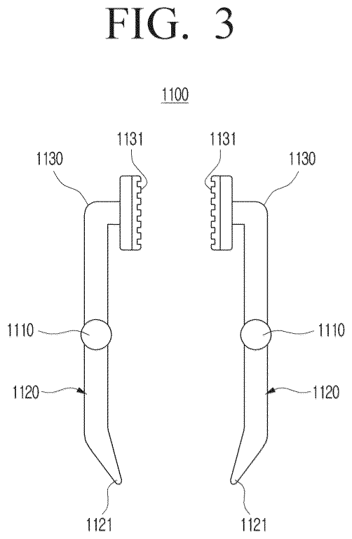

FIG. 3 is a view of a plurality of gripper tips 1100 according to at least one or more embodiments.

The plurality of gripper tips 1100 may include a second connector 1110, a first gripper tip 1120, and a second gripper tip 1130. The second connector 1110 may be disposed in a manner that corresponds to the way that the second connector 1110 protrudes in a direction perpendicular to a lengthwise direction of the plurality of gripper tips 1100 from a center of the plurality of gripper tips 1100. The second connector 1110 may be coupled to the plurality of fingers 1020, 1030 of the gripper 1000. Additionally, the second connector 1110 may be coupled with the rotator 2000 disposed at one side of the gripper 1000. The plurality of gripper tips 1100 may rotate around the second connector 1110. Specifically, the plurality of gripper tips 1100 may rotate around the second connector 1110 such that a gripper tip of a sort corresponding to an identified characteristic may face a target. For example, in a case where a target that has a narrow surface area and is thin is identified based on a sensing value of the at least one sensor 200, the plurality of gripper tips 1100 may rotate around the second connector 1110 such that the first gripper tip 1120 may face the target. On the contrary, in a case where a target having a surface area greater than that of a target grippable by the first gripper tip 1120 is identified based on a sensing value of the at least one sensor 200, the plurality of gripper tips 1100 may rotate around the second connector 1110 such that the second gripper tip 1130 may face the target.

The first gripper tip 1120 may include a first grip part 1121. The first grip part 1121 may have a sharp end. The first grip part 1121 may be formed in a manner that corresponds to the way that the first grip part bends at a certain angle in the lengthwise direction of the plurality of gripper tips 1100. Specifically, the first grip part 1121 may be formed in a manner that corresponds to the way that the first grip part 1121 bends at a certain angle in the lengthwise direction of the plurality of gripper tips 1100 such that the first grip parts 1121 gather together. By doing so, the first gripper tip 1120 may grip a target that has a small contact surface and is thin.

The second gripper tip 1130 may include a second grip part 1131. The second grip part 1131 may have a wide end. The second grip part 1131 may have an uneven element at one side thereof. Specifically, the uneven element of the second grip part 1131 may be an elastomer. For example, the uneven element may be made of various materials such as rubber, silicone, polyurethane, EPDM and the like. Accordingly, the second gripper tip 1130 may grip a target having a contact surface greater than that of a target grippable by the first gripper tip 1120.

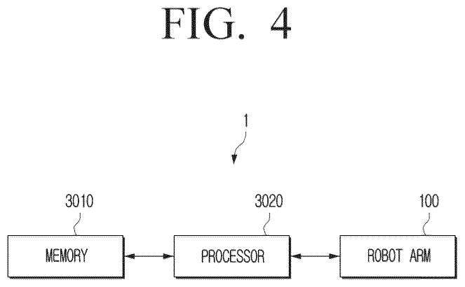

FIG. 4 is a block diagram of a robot apparatus 1 according to one or more embodiments.

The robot apparatus 1 may include a robot arm 100, memory 3010 and a processor 3020.

The memory 3010 is an element for including various types of programs, instructions, data and the like required for operations of the robot apparatus 1. The memory 3010 may store at least one instruction. FIG. 4 shows the memory 3010 separate from the processor 3020, but the disclosure is not necessarily limited thereto, and the memory 3010 may be implemented as internal memory such as ROM (e.g., electrically erasable programmable read-only memory (EEPROM)), RAM, and the like, included in the processor 3020.

Alternatively, the memory 3010 may be implemented in the form of memory embedded in the robot apparatus 1 or in the form of memory detachable from the robot apparatus 1 depending on a data storage purpose. Specifically, the memory 3010 may be implemented as various types of memory such as volatile memory (e.g., static RAM (SRAM) or synchronous dynamic RAM (SDRAM), and the like), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory, hard drive, or solid-state drive (SSD), compact flash (CF), secure digital (SD), micro secure digital (MicroSD), mini secure digital (Mini-SD), extreme digital (xD), multi-media card (MMC) and the like), and the like.

In the disclosure, the term memory 3010 may have a meaning including a storage part, ROM in the processor 3020, RAM in the processor 3020, or a memory card (e.g., a micro SD card, a memory stick) mounted in an electronic apparatus. FIG. 4 shows one memory 3010, but the memory 3010 may be implemented in various numbers.

The memory 3010 is an element for storing at least one instruction, operating system (O/S), program and data and the like in association with the robot apparatus 1.

The memory 3010 may be accessed by the processor 3020, and in the memory 3010, reading/recording/correcting/deleting/updating and the like of data may be performed by the processor 3020.

Specifically, in the memory 3010, various types of information such as information on an assembly state of each joint of the robot arm 100, information on the gripper 1000 of the robot arm 100, information on the plurality of gripper tips 1100, information on each of the plurality of gripper tips 1100, information on the rotator 2000 capable of changing the plurality of gripper tips 1100, information on a characteristic of a target, information on a size rage of a pre-set target, information on current disposition of the gripper tip 1120, 1130, information on a first pre-set distance range, information on a pre-set range in which a task is performed and the like, a program for controlling operations of the robot apparatus 1 and other devices, instructions and the like may be stored.

The memory 3010 may store a plurality of pre-trained artificial intelligence (AI) models. For example, the AI models may be implemented as convolutional neural network (CNN), Long Short-Term Memory (LSTM), Deep Neural Network (DNN), Recurrent Neural Network (RNN), Restricted Boltzmann Machine (RBM), Deep Belief Network (DBN), Bidirectional Recurrent Deep Neural Network (BRDNN), and the like, but the disclosure is not limited thereto. Such an AI model, as a computing system implemented based on a neural network of the brain of a human or an animal, may also be referred to as a learning model, a machine learning model, a neural network model, a deep learning model and the like. In the memory 3010, a database on the sort of a gripper tip corresponding to each characteristic of a target may be stored. Additionally, an AI model trained to select a gripper tip suitable for the characteristic of a target may be stored in the memory 3010.

The processor 3020 controls entire operations of the robot apparatus 1. For example, the processor 3020 may be connected with an element of the robot apparatus including the memory 3010, and by executing at least one instruction stored in the above-described memory 3010, control the entire operations of an electronic apparatus. In particular, the processor 3020 may be implemented as one processor or a plurality of processors.

The processor 3020 may be implemented as one or more integrated circuit (or circuitry) (IC) chips, and perform various types of data processing. The processor 3020 may include at least one electric circuit, and perform distribution processing of instructions (or programs, data, and the like) stored in memory individually or collectively.

The processor 3020 may include a processor set including one or more processing circuits. The processor 3020 may include any processing circuit operative to control performance and operations of one or more elements (e.g., memory and/or a driving device (a sensor)) of a robot apparatus. For example, a processor 3020 (e.g., AP) may be implemented as a system on a chip (SoC; e.g., a single chip or a chip set). For example, the processor 3020 may be implemented as a plurality of cores (or at least one core circuit), a plurality of chips or a plurality of chip sets.

For example, the processor 3020 may include one or more processing circuits. Additionally, the processor 3020 may include one or more processing circuits (or one more processors) configured to perform various functions of the disclosure individually and/or collectively. As a non-limited example, at least part of the processor 3020 may be included in a first chip of the robot apparatus 1, and at least the other part of the processor 3020 may be included in a second chip of the robot apparatus 1 different from the first chip of the robot apparatus 1.

For example, the processor 3020 may include a central processing unit (CPU), a graphics processing unit (GPU), a neural processing unit (NPU), an image signal processor (ISP), a display controller, a memory controller, a storage controller, a communication processor (CP) and/or a sensor interface. The above-described elements of the processor 3020 are described merely as examples. The processor 3020 may further include other elements in addition to the above-described elements. Additionally, part of the elements of the processor 3020 may be omitted. Further, part of the elements of the processor 3020 may be included as a separate clement of the robot apparatus 1 outside the processor 3020. For example, part of the elements (e.g., a memory controller) of the processor 3020 may be included in other elements (e.g., at least part of memory, an interface (e.g., used to connect to at least one element of a robot apparatus 1), a display).

The processor 3020 may cause the other elements of the robot apparatus 1 to perform various operations by executing instructions stored in the memory 3010. The processor 3020 may process a set value, a function instruction and the like based on a pre-stored control program or control data, and output a control signal in association with functions performable by the robot apparatus 1 or a communication signal for communicating with an external robot apparatus. The processor 3020 may also perform at least one of the above-described operations based on an AI model. A processor 3020 for executing an AI model may be implemented based on a combination of a generic-purpose processor such as a CPU, an AP, a digital signal processor (DSP) and the like, a graphics-exclusive processor such as a GPU, and a vision processing unit (VPU) or an AI-exclusive processor such as an NPU with software.

In a case where the processor 3020 is implemented as an AI-exclusive processor, the processor may also be designed as a hardware chip such as an ASIC, an FPGA and the like specializing in processing a specific AI model, and the like.

In a case where the processor 3020 is implemented as a generic-purpose processor, the processor 3020 may be implemented to include memory 3010 for implementing the embodiments of the disclosure, or implemented to include a memory processing function for using external memory. The processor 3020 may be implemented as a single one or a plurality of ones. Additionally, the processor 3020 may perform various operations based on programs, instructions, data and the like stored in the memory 3010.

The processor 3020 may identify a characteristic of a target based on a sensing value of the at least one sensor 200. Herein, the target denotes an object that is grippable such that the robot apparatus 1 may perform a specific task. The processor 3020 may control the robot arm 100 to grip a target by using a gripper tip of a sort corresponding to the identified characteristic of the target among the plurality of gripper tips 1100. Additionally, the processor 3020 may control the plurality of joints 101, 102, 103, the gripper 1000, the plurality of fingers 1020, 1030, the rotator 2000 and the like of the robot arm 100 to grip the target by using a gripper tip of a sort corresponding to the identified characteristic of the target, among the plurality of gripper tips 1100.

Further, the processor 3020 may control the robot arm 100 to detach the plurality of gripper tips 1100 from the connector 1110 and to attach the gripper tip corresponding to the identified characteristic so that the gripper tip faces the target.

For example, in a case where the gripper tip is changed from the first gripper tip 1120 to the second gripper tip 1130, the processor 3020 may control the robot arm 100 to detach the first gripper tip 1120 from the connector 1110 and attach the second gripper tip 1130 to the second connector 1110.

However, the method of controlling the robot arm 100 to detach the plurality of gripper tips 1100 from the connector 1110 such that a gripper tip of a sort corresponding to an identified characteristic faces a target among the plurality of gripper tips 1100 may not be limited thereto, and may include various methods.

In the description provided hereafter, the plurality of joints 101, 102, 103, the gripper 1000, the plurality of fingers 1020, 1030, the rotator 2000 and the like of the robot arm 100 may be controlled respectively, but this is to be understood as controlling the robot arm 100.

The processor 3020 may rotate the rotator 2000 such that a gripper tip of a sort corresponding to an identified characteristic of a target faces the target among the plurality of gripper tips 1100. For example, in a case where a gripper tip appropriate for an identified characteristic of a target is the first gripper tip 1120 among the plurality of gripper tips 1100, the processor 3020 may rotate the first gripper tip 1120 to a position at which the first gripper tip 1120 is capable of gripping the target by using the rotator 2000. However, in a case where the first gripper tip 1120 is already placed at the grippable position before the robot apparatus 1 senses the characteristic of the target through the at least one sensor 200, the processor 3020 may not perform additional control. Likewise, in a case where a gripper tip appropriate for an identified characteristic of a target is the second gripper tip 1130 among the plurality gripper tips 1100, the processor 3020 may rotate the second gripper tip 1130 to a position at which the second gripper tip 1130 is capable of gripping the target by using the rotator 2000. However, in a case where the second gripper tip 1130 is already placed at the grippable position before the robot apparatus 1 senses the characteristic of the target through the at least one sensor 200, the processor 3020 may not perform additional control.

In a case where a size of a target is less than a pre-set size range, the processor 3020 may control the robot arm 100 to grip the target by using the first gripper tip 1120, and in a case where a size of a target is greater than or equal to the pre-set size range, the processor 3020 may control the robot arm 100 to grip the target by using the second gripper tip 1130. Herein, the pre-set size range may be set based on a maximum size range of a target, in which the first gripper tip is selectable. However, the pre-set size range may not be limited thereto, and may be set to various size ranges such as a minimum size range and the like of a target, in which the second gripper tip is selectable. Herein, the pre-set size range may be previously stored in the memory.

The processor 3020 may identify a spatial characteristic of a space in which a target is placed based on a sensing value of the at least one sensor 200. Specifically, in a case where at least one object is placed around a target in a space where the target is placed, the processor 3020 may identify a spatial characteristic of the space based on a sensing value of the at least one sensor 200. The processor 3020 may select a gripper tip 1120, 1130 of the robot arm 100 based on the spatial characteristic of the space in which the target is placed and a characteristic of the target. Herein, a spatial characteristic of a space in which a target is placed may include various types of information such as coordinate information of a position of the target, coordinate information of objects around the target, and the like. Additionally, a spatial characteristic of a space in which a target is placed may include information on at least one of a position of the target in the space, a distance between the target and at least one object placed around the target, and a contact relationship between the target and an object. A characteristic of a target may include various types of information such as a size, material, shape and the like of the target. Additionally, a characteristic of a grip point may be included in a characteristic of a target.

The processor 3020 may identify a characteristic of a grip point of a target based on a sensing value of the at least one sensor 200. The processor 3020 may select a gripper tip 1120, 1130 of the robot arm 100 based on a characteristic of a grip point of a target, a spatial characteristic of a space in which the target is placed and a characteristic of the target. Herein, the characteristic of the grip point of the target may include various types of information such as information on a position of a smallest torque value, information on a position of center of gravity and the like, based on the size, material, shape and the like of the target.

In a case where a target is place at an edge portion of a space in which the target is placed, the processor 3020 may grip the target by using the second gripper tip 1130. Herein, the edge portion may be a region such as an edge of a table and the like, from which the target may fall. In a case where a distance between a target and a surrounding object is less than a first pre-set distance, the processor 3020 may grip the target by using the first gripper tip 1120. In a case where a distance between a target and a surrounding object is greater than or equal to the first pre-set distance, the processor 3020 may grip the target by using the second gripper tip 1130. Herein, the first pre-set distance may correspond to a distance less than a grippable range of the second gripper tip 1130. Additionally, the first pre-set distance may be identical with a size range of an object grippable by the first gripper tip 1120. However, the first pre-set distance may not be limited thereto, and vary depending on user settings.

In the state where a target and a surrounding object contact each other, the processor 3020 may grip the target by using the first gripper tip 1120.

The processor 3020 may select a gripper tip 1120, 1130 corresponding to a characteristic of a target, based on a database on the sorts of the gripper tips 1120, 1130 corresponding to each characteristic of the target.

The processor 3020 may select a gripper tip 1120, 1130 of the robot arm 100 based on a sort of an operation to be performed after gripping the target.

In a case where the operation to be performed after gripping the target is a lifting operation, the processor 3020 may grip the target by using the second gripper tip 1130. In a case where the operation to be performed after gripping the target is a changing operation of changing in a direction where the target is placed, the processor 3020 may grip the target by using the first gripper tip 1120. In a case where the operation to be performed after gripping the target is a tasking operation of performing a task while moving the target within a pre-set range, the processor 3020 may control the robot arm 100 to grip the target by using the first gripper tip 1120. Herein, the pre-set range may be a range in which an elaborate task is performable. However, the pre-set range may not be limited thereto, and may vary depending on user settings.

The processor 3020 may select a gripper tip 1120, 1130 of the robot arm 100 based on an output value of an AI model by inputting information on a characteristic of a target to the AI model. Herein, the AI model may be a model trained to select a gripper tip 1120, 1130 suitable for a characteristic of a target.

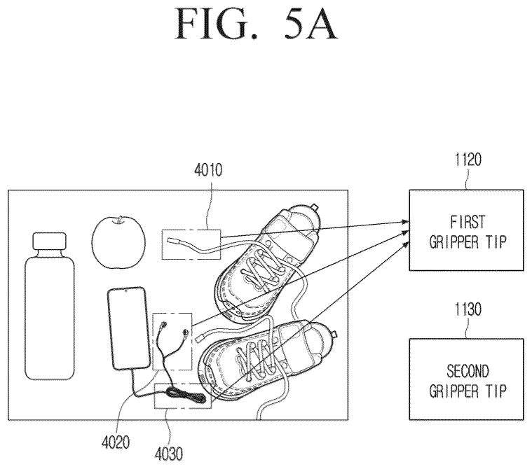

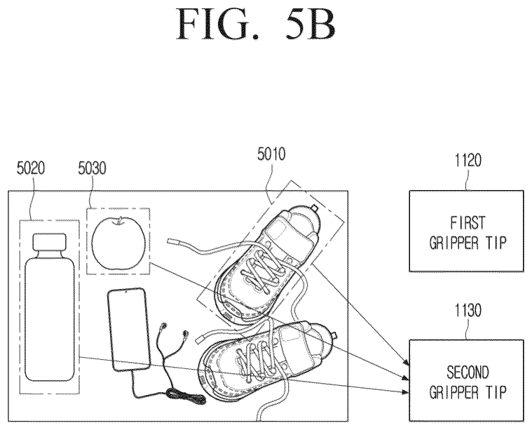

FIG. 5A and FIG. 5B are views provided to explain a method of selecting a gripper tip 1120, 1130 based on a characteristic of a target according to one or more embodiments. FIG. 5A and FIG. 5B are views provided to explain a method of selecting a gripper tip 1120, 1130 of a sort corresponding to an identified characteristic of a target among various targets FIG. 5A is a view provided to explain a method of selecting the first gripper tip 1120 among the plurality of gripper tips 1100, and FIG. 5B is a view provided to explain a method of selecting the second gripper tip 1130 among the plurality of gripper tips 1100.

In FIG. 5A and FIG. 5B, as a target, shoes, a mobile phone, an earbud, an apple, a vacuum flask and the like are disposed on a table. The robot apparatus 1 may sense information on a target and a surrounding shape and the like, based on a sensing value of the at least one sensor 200. In FIG. 5A, the robot apparatus 1 may sense position information of the vacuum flask, position information of the apple, position information of the shoes, position information of the shoelaces, position information of the mobile phone, position information of the earbuds and the like, based on a sensing value of the at least one sensor 200. Additionally, the robot apparatus 1 may sense information on a shape, material, size and the like of the vacuum flask, apple, shoes, shoelaces, mobile phone and earbuds and the like, based on a sensing value of the at least one sensor 200.

In FIG. 5A, when sensing that a size of a target is less than a pre-set size range based on a sensing value of the at least one sensor 200, the robot apparatus 1 may select the first gripper tip 1120 based on a characteristic of the target. For example, when sensing shoelaces 4010, an earbud fastener 4020 and an earbud strap 4030 as a grippable target based on a sensing value of the at least one sensor 200, the robot apparatus 1 may select the first gripper tip 1120 based on a characteristic of the target since a size of the target is less than the pre-set size range.

In a case where a gripper tip appropriate for an identified characteristic of a target is the first gripper tip 1120 among the plurality of gripper tips 1100, the robot apparatus 1 may rotate the first gripper tip 1120 to a position at which the target is grippable, by using the rotator 2000 of the robot apparatus 1. However, in a case where the first gripper tip 1120 is already placed at the grippable position before the robot apparatus 1 senses the characteristic of the target through the at least one sensor 200, the robot apparatus 1 may not perform additional control.

In FIG. 5B, when sensing that a size of a target is greater than or equal to the pre-set size range based on a sensing value of the at least one sensor 200, the robot apparatus 1 may select the second gripper tip 1130 based on a characteristic of the target. For example, when sensing shoes 5010, a vacuum flask 5020, and an apple 5030 as a grippable target based on a sensing value of the at least one sensor 200, the robot apparatus 1 may select the second gripper tip 1120 (1130) based on a characteristic of the target since a size of the target is greater than or equal to the pre-set size range.

Herein, the robot apparatus 1 may change the gripper tip from the first gripper tip 1120 to the second gripper top 1130 or from the second gripper tip 1130 to the first gripper tip 1120 by using the rotator 2000.

In FIG. 5B, in a case where a gripper tip appropriate for an identified characteristic of a target is the second gripper tip 1130 among the plurality of gripper tips 1100, the robot apparatus 1 may rotate the second gripper tip 1130 to a position at which the target is grippable, by using the rotator 2000. However, in a case where the second gripper tip 1130 is already placed at the grippable position before the robot apparatus 1 senses the characteristic of the target through the at least one sensor 200, the robot apparatus 1 may not perform additional control.

Then, in FIG. 5A and FIG. 5B, the robot apparatus 1 may identify a position of a grip point of the target based on a sensing value of the at least one sensor 200, and grip the target by using the gripper tip 1120, 1130.

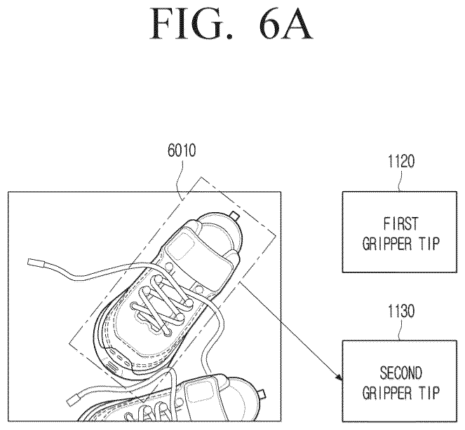

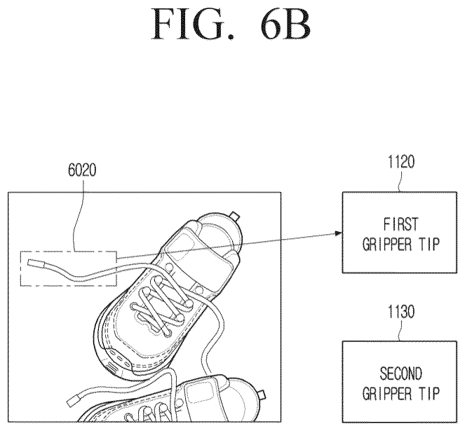

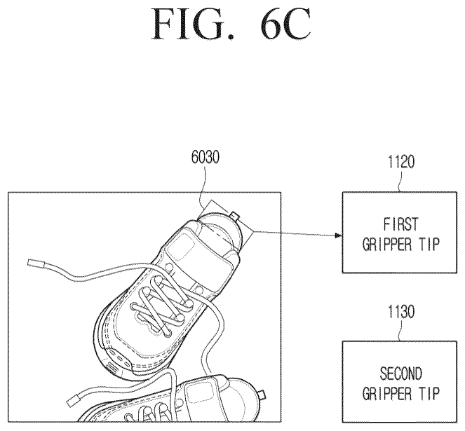

FIG. 6A-FIG. 6C are views provided to explain a method of selecting a gripper tip 1120, 1130 based on a characteristic of a target according to one or more embodiments.

FIG. 6A is a view provided to explain a method of selecting the second gripper tip 1130 based on a characteristic of a first target 6010 that is an entire shoe, FIG. 6B is a view provided to explain a method of selecting the first gripper tip 1120 based on a characteristic of a second target 6020 that is a shoelace, and FIG. 6C is a view provided to explain a method of selecting the first gripper tip 1120 based on a characteristic of a third target 6030 that is a shoe heel.

In FIG. 6A-FIG. 6C, the robot apparatus 1 has identified characteristics of the targets illustrated in FIG. 5A and FIG. 5B based on a sensing value of the at least one sensor 200 and has determined to grip each element of a shoe.

In FIG. 6A-FIG. 6C, the robot apparatus 1 may identify the first target 6010 that is an entire shoe, the second target 6020 that is a shoelace, and the third target 6030 that is a shoe heel based on a sensing value of the at least one sensor 200. Herein, as for the robot apparatus 1, a gripper tip 1120, 1130 of a sort corresponding to an identified characteristic of a target among the plurality of gripper tips 1100 may differ depending on a specific task set by the user.

In a case where the user sets a task of gripping and moving the first target 6010 in FIG. 6A, the robot apparatus 1 may select the second gripper tip 1130 that is a gripper tip 1120, 1130 of a sort corresponding to the first target 6010 based on a sensing value of the at least one sensor 200.

In a case where the user sets a task of tying shoelaces in FIG. 6B, the robot apparatus 1 may select the first gripper tip 1120 that is a gripper tip 1120, 1130 of a sort corresponding to the second target 6020 based on a sensing value of the at least one sensor 200.

In a case where the user sets a task of assisting when the user wears shoes in FIG. 6C, the robot apparatus 1 may select the first gripper tip 1120 that is a gripper tip 1120, 1130 of a sort corresponding to the third target 6030 based on a sensing value of the at least one sensor 200.

However, a gripper tip 1120, 1130 may not be limited thereto, and as for the robot apparatus 1, a gripper tip 1120, 1130 of a sort corresponding to a target may differ depending on a task set by the user.

Then in FIGS. 6A, 6B, and 6C, the robot apparatus 1 may identify a position of a grip point of the target based on a sensing value of the at least one sensor 200, and grip the target 6010, 6020, 6030 by using the gripper tip 1120, 1130.

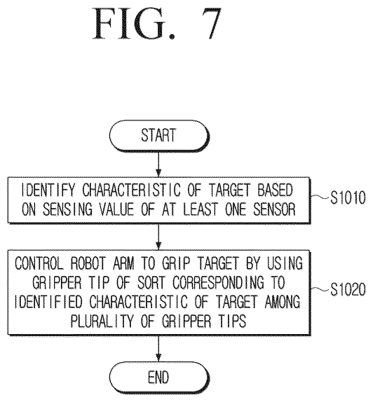

FIG. 7 is a view of a flowchart of method of operating a robot apparatus 1 according to one or more embodiments.

In FIG. 7, the robot apparatus 1 may identify a characteristic of a target based on a sensing value of the at least one sensor 200 (S1010). The robot apparatus 1 may control the robot arm 100 to grip the target by using a gripper tip 1120, 1130 of a sort corresponding to the identified characteristic of the target among the plurality of gripper tips 1100 (S1020).

The robot apparatus 1 may rotate the rotator 2000 such that the gripper tip 1120, 1130 of the sort corresponding to the identified characteristic of the target may face the target among the plurality of gripper tips 1100.

In a case where a size of the target is less than a pre-set size range, the robot apparatus 1 may grip the target by using the first gripper tip 1120. In a case where a size of the target is greater than or equal to the pre-set size range, the robot apparatus 1 may grip the target by using the second gripper tip 1130.

Herein, a characteristic of a target, the robot arm 100, the plurality of gripper tips 1100, the first gripper tip 1120, the second gripper tip 1130 and the like are specifically described above, and accordingly, further description in relation to this is omitted.

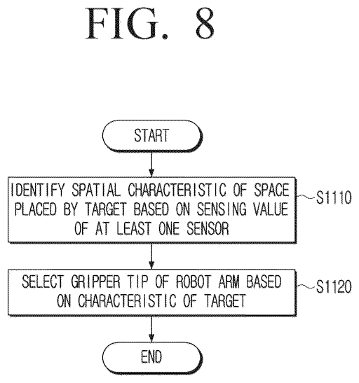

FIG. 8 is a view of a flowchart of a method of operating a robot apparatus 1 according to one or more embodiments.

In FIG. 8, the robot apparatus 1 may identify a spatial characteristic of a space in which a target is placed, based on a sensing value of the at least one sensor 200 (S1110). Then the robot apparatus 1 may select a gripper tip 1120, 1130 of the robot arm 100 based on a characteristic of the target (S1120).

The robot apparatus 1 may identify a characteristic of a grip point of the target based on a sensing value of the at least one sensor 200. Additionally, the robot apparatus 1 may select a gripper tip 1100 of the robot arm 100 based on the characteristic of the grip point, the spatial characteristic of the space in which the target is placed and the characteristic of the target.

Herein, the spatial characteristic of the space in which the target is placed, the characteristic of the target, the characteristic of the grip point and the like are specifically described above, and accordingly, further description in relation to this is omitted.

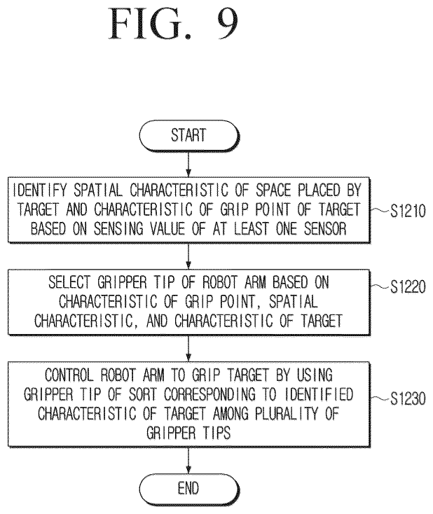

FIG. 9 is a view of a flowchart of method of operating a robot apparatus 1 according to one or more embodiments.

The robot apparatus 1 may identify a spatial characteristic of a space in which a target is placed and a characteristic of a grip point of the target, based on a sensing value of the at least one sensor 200 (S1210). The robot apparatus 1 may select a gripper tip of the robot arm 100 based on the characteristic of the grip point, the spatial characteristic of the space in which the target is placed and a characteristic of the target (S1220). The robot apparatus 1 may control the robot arm 100 to grip the target by using a gripper tip 1120, 1130 of a sort corresponding to an identified characteristic of the target among the plurality of gripper tips 1100 (S1230).

In a case where the target is placed at an edge portion of the space in which the target is placed, the robot apparatus 1 may select a second gripper tip 1130. Herein, the edge portion of the space in which the target is placed may be a region such as an edge of a table, an edge of a desk, an edge of a wall and the like and the like from which the target is likely to fall out of the space. In a case where a distance between the target and a surrounding object is less than a first pre-set distance, the robot apparatus 1 may select a first gripper tip 1120, and in a case where the distance is greater than or equal to the first distance, the robot apparatus 1 may select a second gripper tip 1130. The first pre-set distance is described above, and accordingly, further description in relation to this is omitted.

The robot apparatus 1 may select the first gripper tip 1120 in the state where the target and the surrounding object contact each other.

In a case where an operation to be performed after the grip of the target is a lifting operation, the robot apparatus 1 may grip the target by using the second gripper tip 1130. In a case where an operation to be performed after the grip of the target is an operation of changing a direction in which the target is placed, the robot apparatus 1 may grip the target by using the first gripper tip 1120. In a case where an operation to be performed after the grip of the target is a tasking operation of performing a task while moving the target in a pre-set range, the robot apparatus 1 may grip the target by using the first gripper tip 1120.

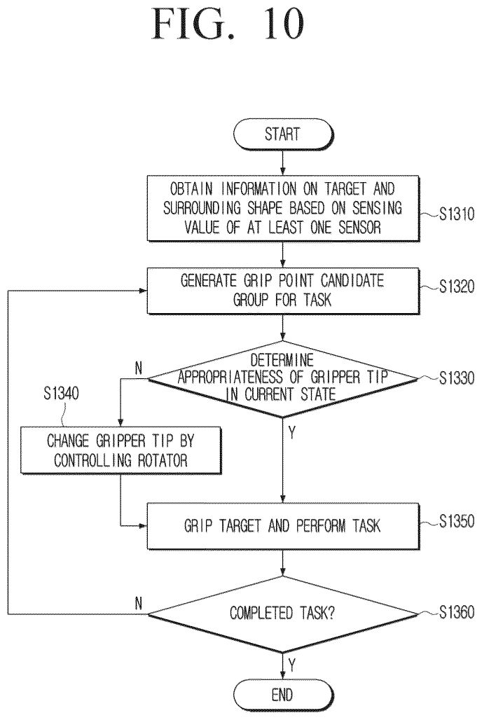

FIG. 10 is a view of a flowchart of a method of operating a robot apparatus 1 according to one or more embodiments.

The robot apparatus 1 may obtain information on a target and a surrounding shape based on a sensing value of the at least one sensor 200 (S1310). Then the robot apparatus 1 may generate a grip point candidate group for performing a task (S1320). Herein, the grip point candidate group may vary depending on a task set by the user. The grip point candidate group may vary depending on a characteristic of a target. Then the robot apparatus 1 may determine appropriateness of a gripper tip 1120, 1130 in a current state (S1330). Herein, when determining that a gripper tip 1120, 1130 in a current state is appropriate, the robot apparatus 1 may grip a target and perform a task by using the gripper tip 1120, 1130 in the current state (S1350). On the contrary, when determining that a gripper tip 1120, 1130 in a current state is inappropriate, the robot apparatus 1 may control the rotator 2000 and change the gripper tip 1120, 1130 (S1340). Then the robot apparatus 1 may grip a target and perform a task by using a gripper tip 1120, 1130 that is changed by using the rotator 2000 (S1350). Then the robot apparatus 1 may determine whether the task is completed (S1360). Having determined that the task is completed, the robot apparatus 1 may end the task. On the contrary, having determine that the task is not completed, the robot apparatus 1 may perform an operation again from the operation of generating a grip point candidate group of a target for a task.

Each of the elements described in the present disclosure may be comprised of one or more components, and the name of the element may vary depending on the sort of an electronic apparatus.

One or more embodiments according to the disclosure are respectively described above, but each of the embodiments may not be necessarily implemented solely, and the configuration and operation of each of the embodiments may be implemented in combination with at least one of other embodiments.

According to the above-described embodiments, an AI model trained to select a gripper tip suitable for a characteristic of a target may be used to select a gripper tip, thereby securing improvement in accuracy of selection of a gripper tip, and may provide a high-level AI function to users, thereby meeting user satisfaction.

The embodiments according to the disclosure may be implemented with software stored in a storage medium (a machine-readable storage medium) that is mountable in or connectable to a robot apparatus.

Specifically, a non-transitory machine-readable storage medium storing software for performing operations sequentially may be provided, the operations including identifying a spatial characteristic of a space in which a target is placed and a characteristic of a grip point of the target based on a sensing value of at least one sensor, selecting a gripper tip of a robot arm based on the characteristic of the grip point of the target, the spatial characteristic of the space in which the target is placed and a characteristic of the target, and controlled a robot arm and gripping the target by using a gripper tip of a sort corresponding to the identified characteristic of the target among a plurality of gripper tips.

An apparatus in which the non-transitory machine-readable storage medium is mounted may perform various operations such as identifying a spatial characteristic of a space in which a target is placed, a characteristic of a grip point and a characteristic of a target, controlling a robot arm, selecting a gripper tip and the like that are described with reference to the above embodiments.

In the non-transitory machine-readable storage medium, the term “non-transitory” only means that a storage medium includes no signal and is tangible, while the term does not distinguish semi-permanent storage and temporary storage of data in the storage medium.

Alternatively, a program for performing the method according to the above-described embodiments may be distributed online through an application store. In the case of online distribution, at least part of a computer program product (e.g., a downloadable app) may be stored at least temporarily, or generated temporarily in a storage medium such as a server of a manufacturer, a server of an application store, or memory of a relay server.

Each of the elements (e.g., a module or a program) according to the embodiments may be comprised of a single entity or a plurality of entities, and part of the corresponding sub elements described above may be omitted, or another sub element may be further included in the embodiments. Alternatively or additionally, part of the elements (e.g., modules or programs) may be integrated into one entity to perform identical or similar functions performed by each corresponding element prior to the integration. Operations performed by a module, a program, or another element, according to the embodiments, may be executed sequentially, in parallel, repetitively, or heuristically, or at least part of the operations may be executed in a different order, may be omitted, or may add a different operation.

While the example embodiments of the present disclosure are illustrated and described above, embodiments of the disclosure are not limited to the embodiments set forth herein, and certainly, various modifications thereof may be made by those skilled in the art to which the disclosure pertains, without departing from the scope the disclosure claimed in the section of claims, and should not be understood as separating from the technical spirit or prospect of the disclosure.

What is claimed is:

1. A robot apparatus comprising:
a main body;
a robot arm connected to the main body and configured to selectively use a plurality of gripper tips;
at least one sensor;
memory storing at least one instruction; and
at least one processor configured to execute the at least one instruction,
wherein the at least one instruction, when executed by the at least one processor individually or collectively, causes the robot apparatus to:
identify a characteristic of a target based on a sensing value of the at least one sensor; and
control the robot arm to grip the target by using a gripper tip corresponding to the identified characteristic among the plurality of gripper tips.

2. The robot apparatus of claim 1, wherein the robot arm comprises:
a rotator on which each of the plurality of gripper tips are mounted, wherein each of the plurality of gripper tips is mounted in a different direction, and
wherein the at least one instruction, when executed by the at least one processor individually or collectively, further causes the robot apparatus to:
rotate the rotator such that the gripper tip corresponding to the identified characteristic faces the target.

3. The robot apparatus of claim 1, wherein the robot arm comprises:
a coupler detachably connected to the plurality of gripper tips, and
wherein the at least one instruction, when executed by the at least one processor individually or collectively, further causes the robot apparatus to:
control the robot arm to detach the plurality of gripper tips from the connector and to attach the gripper tip corresponding to the identified characteristic so that the gripper tip faces the target.

4. The robot apparatus of claim 1, wherein the plurality of gripper tips comprises a first gripper tip and a second gripper tip, and a contact surface of the second gripper tip is larger than a contact surface of the first gripper tip, and
wherein the at least one instruction, when executed by the at least one processor individually or collectively, further causes the robot apparatus to:
based on a size of the target being less than a pre-set size range, control the robot arm to grip the target by using the first gripper tip; and
based on the size of the target being greater than or equal to the pre-set size range, control the robot arm to grip the target by using the second gripper tip.

5. The robot apparatus of claim 1, wherein the plurality of gripper tips comprises a first gripper tip and a second gripper tip, and a contact surface of the second gripper tip is larger than a contact surface of the first gripper tip, and
wherein the at least one instruction, when executed by the at least one processor individually or collectively, further causes the robot apparatus to:
based on identifying at least one object in a vicinity of the target, identify a spatial characteristic of a space where the target is located based on the sensing value of the at least one sensor; and
select the gripper tip from among the plurality of gripper tips based on the spatial characteristic and the characteristic of the target.

6. The robot apparatus of claim 5, wherein the spatial characteristic comprises information on at least one of a position of the target in the space, a distance between the target and the at least one object, and a contact relationship between the target and the at least one object, and
wherein the at least one instruction, when executed by the at least one processor individually or collectively, further causes the robot apparatus to:
based on the target being located at an edge portion of the space, control the robot arm to grip the target using the second gripper tip;
based on the distance being less than a first pre-set distance, control the robot arm to grip the target using the first gripper tip;
based on the distance being greater than or equal to the first pre-set distance, control the robot arm to grip the target using the second gripper tip; and
based on the target and at least one of the at least one object being in contact with one another, control the robot arm to grip the target using the first gripper tip.

7. The robot apparatus of claim 1, wherein the at least one instruction, when executed by the at least one processor individually or collectively, further causes the robot apparatus to select the gripper tip from among the plurality of gripper tips based on an operation to be performed after the target is gripped.

8. The robot apparatus of claim 1, wherein the plurality of gripper tips comprises a first gripper tip and a second gripper tip, and a contact surface of the second gripper tip is larger than a contact surface of the first gripper tip, and
wherein the at least one instruction, when executed by the at least one processor individually or collectively, further causes the robot apparatus to:
based on an operation to be performed after the target is gripped being a lifting operation, control the robot arm to grip the target using the second gripper tip;
based on the operation comprising changing a direction where the target is placed, control the robot arm to grip the target using the first gripper tip; and
based on the operation comprising performing a task while moving the target within a pre-set range, control the robot arm to grip the target using the first gripper tip.

9. The robot apparatus of claim 1, wherein the memory stores a database of a plurality of types of gripper tips,
wherein each of the plurality of types of gripper tips corresponds to one or more characteristics of the target, and
wherein the at least one instruction, when executed by the at least one processor individually or collectively, further causes the robot apparatus to select, based on the database, the gripper tip corresponding to the characteristic of the target from among the plurality of gripper tips.

10. The robot apparatus of claim 1, wherein the memory stores an artificial intelligence model trained to select the gripper tip corresponding to the identified characteristic of the target from among the plurality of gripper tips, and
wherein the at least one instruction, when executed by the at least one processor individually or collectively, further causes the robot apparatus to:
input information on the characteristic of the target to the artificial intelligence model; and
select the gripper tip based on an output value of the artificial intelligence model from among the plurality of gripper tips.

11. A method of controlling a robot apparatus including at least one sensor and a robot arm capable of selectively using a plurality of gripper tips, the method comprising:
identifying a characteristic of a target based on a sensing value of the at least one sensor; and
controlling the robot arm to grip the target using a gripper tip corresponding to the identified characteristic among the plurality of gripper tips.

12. The method of claim 11, wherein the robot arm further includes a rotator on which each of the plurality of gripper tips is mounted in a different direction, and
wherein the controlling the robot arm further comprises rotating the rotator such that the gripper tip corresponding to the identified characteristic faces the target.

13. The method of claim 11, wherein the plurality of gripper tips includes a first gripper tip and a second gripper tip, and a contact surface of the second gripper tip is larger than a contact surface of the first gripper tip, and
wherein the controlling the robot arm further comprises, based on a size of the target being less than a pre-set size range, gripping the target using the first gripper tip, and based on a size of the target being greater than or equal to the pre-set size range, gripping the target using the second gripper tip.

14. The method of claim 13, further comprising:
identifying a spatial characteristic of a space where the target is located based on the sensing value of the at least one sensor,
wherein the controlling the robot arm further comprises selecting a gripper tip of the robot arm, from among the plurality of gripper tips, based on the characteristic of the target.

15. The method of claim 14, wherein the identifying the spatial characteristic of the space where the target is located based on the sensing value of the at least one sensor comprises:
identifying a characteristic of a grip point of the target based on the sensing value of the at least one sensor, and
wherein the selecting the gripper tip of the robot arm based on the characteristic of the target comprises selecting the gripper tip of the robot arm based on the characteristic of the grip point, the spatial characteristic, and the characteristic of the target.

16. A non-transitory computer readable medium having instructions stored therein, which when executed by at least one processor cause the at least one processor to execute a method of controlling a robot apparatus, the method comprising:
identifying a characteristic of a target based on a sensing value of at least one sensor of the robot apparatus; and
controlling a robot arm of the robot apparatus to grip the target using a gripper tip corresponding to the identified characteristic from among a plurality of gripper tips of the robot arm.

17. The non-transitory computer readable medium of claim 16, wherein the robot arm further includes a rotator on which each of the plurality of gripper tips is mounted in a different direction, and
wherein the controlling the robot arm further comprises rotating the rotator such that the gripper tip corresponding to the identified characteristic faces the target.

18. The non-transitory computer readable medium of claim 16, wherein the plurality of gripper tips includes a first gripper tip and a second gripper tip, and a contact surface of the second gripper tip is larger than a contact surface of the first gripper tip, and
wherein the controlling the robot arm further comprises, based on a size of the target being less than a pre-set size range, gripping the target using the first gripper tip, and based on a size of the target being greater than or equal to the pre-set size range, gripping the target using the second gripper tip.

19. The non-transitory computer readable medium of claim 18, wherein the method further comprises:
identifying a spatial characteristic of a space where the target is located based on the sensing value of the at least one sensor, and
wherein the controlling the robot arm further comprises selecting the gripper tip, from among the plurality of gripper tips, based on the characteristic of the target.

20. The non-transitory computer readable medium of claim 19, wherein the identifying the spatial characteristic of the space where the target is located based on the sensing value of the at least one sensor comprises:
identifying a characteristic of a grip point of the target based on the sensing value of the at least one sensor, and
wherein the selecting the gripper tip of the robot arm based on the characteristic of the target comprises selecting the gripper tip of the robot arm based on the characteristic of the grip point, the spatial characteristic, and the characteristic of the target.
